(19) United States
(12) Patent Application Publication
(10) Pub. No.: US 2025/0054084 A1
(43) Pub. Date: Feb. 13, 2025

(54) PLATFORM FOR BROWSING AND ORDERING FOOD

(71) Applicant: Kezo Inc., Houston, TX (US)

(72) Inventor: Francisco Carlos Sanchez, Houston, TX (US)

(73) Assignee: Kezo Inc., Houston, TX (US)

(21) Appl. No.: 18/791,325

(22) Filed: Jul. 31, 2024

Related U.S. Application Data
(60) Provisional application No. 63/531,232, filed on Aug. 7, 2023.

(51) Int. Cl. G06Q 50/12; G06Q 30/0601

(52) U.S. Cl. CPC G06Q 50/12; G06Q 30/0643

(57) ABSTRACT

A system and method providing for a user to browse and order food, including receiving an image and information of a food item from a store for an application, displaying the image and an icon associated with the image on a browsing page in the application, receiving a click on the icon by the user and in response displaying an item page of the food item in the application, receiving an input by the user at the item page to add the food item to a cart, displaying a cart page in the application indicating the food item added to the cart, receiving another input by the user at the cart page to place an order having the food item, indicating to the user that the order has been placed, and providing the order to the store.

### CROSS REFERENCE TO RELATED APPLICATIONS

This application claims the priority of U.S. Provisional Patent Application No. 63/531,232, filed Aug. 7, 2023, which is incorporated by reference in its entirety.

### FIELD

The present disclosure relates generally to computer applications (“apps”) and, more particularly, to a platform for browsing and ordering food.

### BACKGROUND

Users of social media platforms such as Facebook, Instagram, Pinterest, and the like, post pictures of their activities, including pictures of them dining at food establishments and pictures of the food items. Users also browse their social media feeds to get dining ideas.

### BRIEF DESCRIPTION OF THE DRAWINGS

These drawings illustrate certain aspects of some of the embodiments of the present disclosure and should not be used to limit or define the disclosure.

FIG. 1 is a diagram of an example of a browsing page of the present app (platform).

FIG. 2 is a diagram of an item page that may be displayed at the user device by the app in response to the user selecting a link on the browsing page of FIG. 1.

FIG. 3 is a diagram of an example of a cart page, which may be labeled as the cart or a depiction of the cart.

FIG. 4 is a block flow diagram of a method of providing for a user to browse and order food.

FIG. 5 is a diagram of a representation of an application (app) as a platform for a user browsing and ordering food,

FIG. 6 is a diagram of a system that includes a computing system for managing (including configuring) the present application (platform) and interacting (communicating) with stores and users.

FIG. 7 is a diagram of an example of an item page of the app that may be displayed on the user device (computing device).

FIG. 8 is a diagram of an example of a cart page of the app that may be displayed on the user device (computing device).

FIG. 9 is a diagram of an example of an item page of the app that may be displayed on the user device (computing device).

FIG. 10 is a diagram of an example of a cart page of the app that may be displayed on the user device (computing device), and representative of a screenshot on the user device.

FIG. 11 is a diagram of an example of search results of the search term “street tacos” performed with the Google search engine.

FIG. 12 is a block diagram of a tangible, non-transitory, computer (machine) readable medium having the present application and for managing (including configuring) the present application (platform) and interacting (communicating) with stores and users of the application.

FIG. 13 is a diagram of an example of an item page of the app that may be displayed on the user device (computing device).

FIG. 14 is a diagram of an example of a cart page of the app that may be displayed on the user device (computing device).

### DETAILED DESCRIPTION

Some aspects of the present disclosure are directed to a computer or software application (“app”) for browsing and ordering food items. The application can be, for example, a mobile app, desktop app, or website app, and so on. A problem with conventional social media (e.g., Instagram, TikTok, etc.) is there is generally no link (e.g., to a stores item) associated with displayed images of food (food items). Therefore, when a user sees a desired food item on social media, the user must typically go to another (separate) app to locate an analogous food item for purchase.

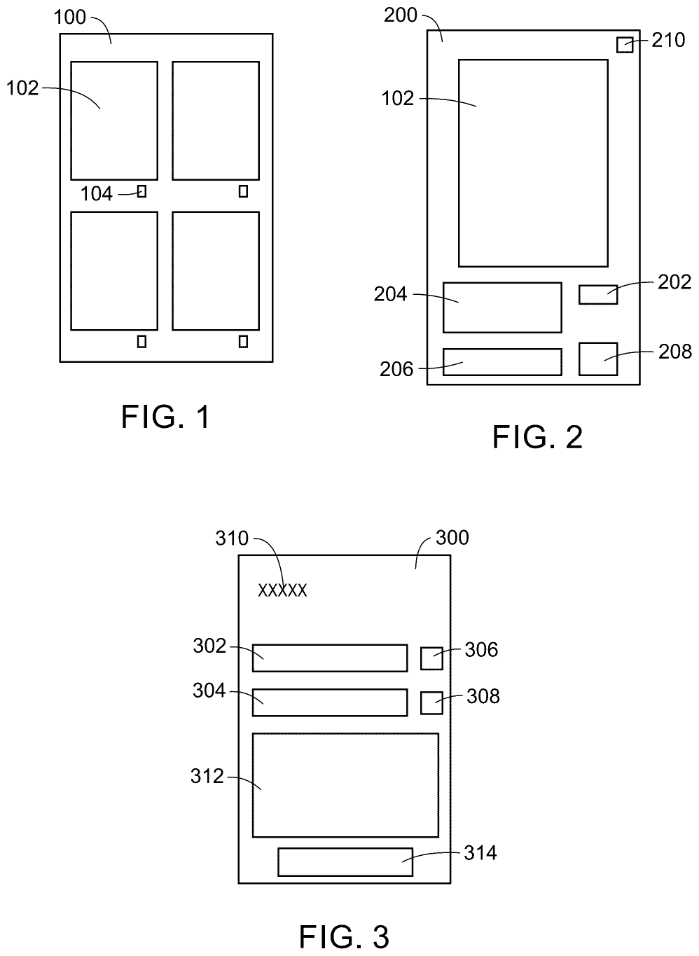

Conversely, embodiments herein are an app that displays on the same browsing page: (1) images of food items for browsing and (2) respective links associating the images with the food items. The link can be selected by the user for consideration of the food item and/or to initiate pursuit of ordering/purchasing the food item depicted in the browsed image. The food items are available for purchase from various respective sources (food providers, stores, restaurants, etc.). Again, the [1] image of the food item and the [2] associated link to pursue the food item are on the same browsing page (e.g., FIG. 1). The user of the app may click on the link (e.g., an icon) to be directed (taken) to an item page in the app that gives a description and price of the food item in or associated with the image. At the item page, the user may add the food item to a cart in the app for subsequent purchase and be taken to a cart page (depicting the cart) where the user can place an order including the food item for purchase.

Therefore, for a user to both (1) browse food items from various sources and (2) purchase a food item, the present app may generally provide for not having to switch (jump, hop) from app to app, as is conventional. Thus, the present app can be more straightforward and streamlined compared to techniques involving combined use of multiple apps to browse and order food.

In embodiments, at the item page, the user may enter (e.g., add or select) a specification (e.g., instruction, choice, alteration, etc.) regarding the food item before or as adding the food item to the cart. Implementations of the present app can accommodate payment of the order (including the food item) placed by the user (e.g., at the cart page). In examples, the present app may provide for arranging or facilitating delivery of the food item along with the user placing the order or making the purchase of the food item.

The present app can be configured to facilitate onboarding of a provider (e.g., store, restaurant, etc.) of food items for the application. The images of the food items browsed by a user can be given by food providers in implementations and received by (entered into) the app configuration. Likewise, information (e.g., price, description, etc.) given by food providers can be received by (entered into) the application. Furthermore, the present app may provide for the user to post images and comments regarding food items and receive rewards (e.g., monetary rewards) in response. Other features are applicable.

The app may generally provide for the user to perform an initial search of food items or types of food items, and which images of the food items (and associated links) of the search results displayed on a browsing page. The search may be performed at a page (e.g., initial page, home page, search page, browsing page, etc.) of the app, and in which the page has a field to receive search terms for the search inquiry. For instance, search terms could include “hot dogs” and the search results as images (of food items that are hot dogs or related to hot dogs) with links displayed on a browsing page.

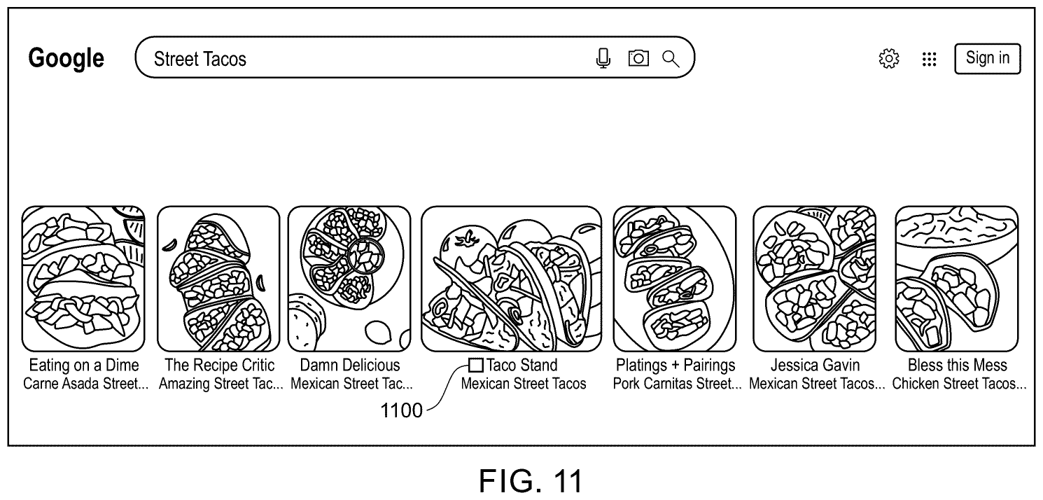

The present app can be configured to interact with social media applications (e.g., Instagram, Facebook, etc.) or search applications (engines), or both. For example, a description and/or image of a food item along with a relevant link to open the present app may be posted on a social media application by an entity (e.g., food provider, user, third party, etc.) with or without aid of the present app. Moreover, food providers or other entities can provide a link (to open the present app) in their information that may appear in search results of search engines (e.g., Google, Bing, etc.). See, for example, FIG. 11.

An embodiment is a method of using (a user employing) an application for browsing and ordering food. The method includes the user browsing images of food items (e.g., on a browsing page or browsing feed) in the application. For the user to select a depicted food item for further consideration or purchase, the method includes the user clicking on a link, such as an icon (e.g., cart icon), button, etc. associated with (e.g., and adjacent to) an image of the food item (one of the images being browsed) desired by the user. In response to the user clicking the link, the application displays an item page (or items page) noting the food item. The method of the user employing the application includes the user optionally entering or selecting a specification (e.g., instruction, choice, alteration, etc.) on the item page. The specification is regarding the food item. The method includes at the item page the user adding (e.g., via clicking a button on the item page) the food item to a cart in the application. The application displays a cart page in response. The cart page can be the cart or indicate that the food item is in the cart. The method includes at the cart page the user ordering (e.g., via clicking a button on the cart page) the cart item(s) including the food item for purchase. Such may be characterized as the user placing an order of the cart item(s) including the food item. The method includes the user receiving an indication that the order has been placed. In implementations, the method includes the user paying for the order via the application.

FIG. 1 is an example of a browsing page 100 of the present app (platform). Again, the present app may be for browsing and ordering food, as discussed. The app may be a mobile application (e.g., for a mobile phone, etc.), tablet application, desktop (personal computer or PC) application, or website application (e.g., accessible at a website via the Internet), and so forth. The browsing page 100 may be displayed by a computing device via the app on a screen or monitor.

The aspect ratio of the browsing page 100 can vary depending, for example, on how configured in the app, the type of the computing device, the type or aspect ratio of the screen or monitor, and the like. The computing device can be a mobile device (e.g., mobile or cellular phone), desktop computer [e.g., personal computer (PC)], or a portable computer such as tablet PC (tablet computer or tablet), notebook, or laptop computer. The app can be code (e.g., instructions, logic, etc.) stored in memory of the computing device and executable by a hardware processor of the computing device.

In the illustrated embodiment, the browsing page 100 (which may also be known as a browsing feed, browsing search results, etc.) includes four images 102 each associated with a link 104, respectively. The browsing page 100 may include additional information (e.g., images, links, etc.) not shown in the example of FIG. 1.

The images 102 are each an image of a food item. The food item in an image 102 on the browsing page 100 may be similar or different than the food item in another (adjacent) image 102 on the browsing page 100. The images 102 may be for or from different providers of food (food items) among the images 102 on the browsing page. In an example, one of the four images 102 may be a hamburger from a restaurant and another of the four images 102 may be a different hamburger from a different restaurant. The images 102 displayed on the browsing page 100 may be the result of a search in the app performed by the user, either at the browsing page 100 or on a different page in the app. In an example, the search term may be “hamburger” and the four images 102 displayed at the browsing page 100 are of hamburgers as the food items from four different restaurants, respectively.

As mentioned, a respective link 104 is associated with each image 102. In implementations, the link 104 includes code when executed displays an item page (e.g., 200 of FIG. 2). The link 104 may be depicted as a button or an icon (e.g., cart icon), and the like, to receive user input to select the link 104, e.g., to activate or initiate execution of the link to display the item page. The link 104 may be disposed adjacent the image 104, such as below (as shown), above, or to the side of the image 104. The link 104 (e.g., shown as an icon) may be disposed on the image 104. In implementations, the link 104 (with no separate depiction visible to the user, e.g., button, icon, etc.) can be selected by the user by clicking on the image 102 itself.

The presence of the image 102 and the link 104 (e.g., on the browsing page 100) provides for a streamlined technique for the user. In particular, the user may browse images 102 of food items (from different respective sources of food providers) on the browsing page 100 and select a link 104 on the browsing page 100 to be taken to an item page of the desired food item. The user selection of the link 104 may be for further consideration or purchase of the desired food item.

FIG. 2 is an item page 200 that may be displayed at the user device by the app in response to the user selecting the link 104 on the browsing page 100 of FIG. 1. In this example, the image 102 (or similar image) associated with the link 104 (FIG. 1) is shown on the item page 200. In the illustrated embodiment, the item page 200 gives the price 202 (in the relevant currency) and a text description 204 of the food item noted by the image 102. The item page 200 may also include a specification interface 206 to receive user entry or selection of a specification regarding the food item. The item page 200 may include an add-to-cart button 208 for the user to click or select to add the food item to a cart for purchase. The depicted item page 200 is only an example and not meant to limit the present techniques.

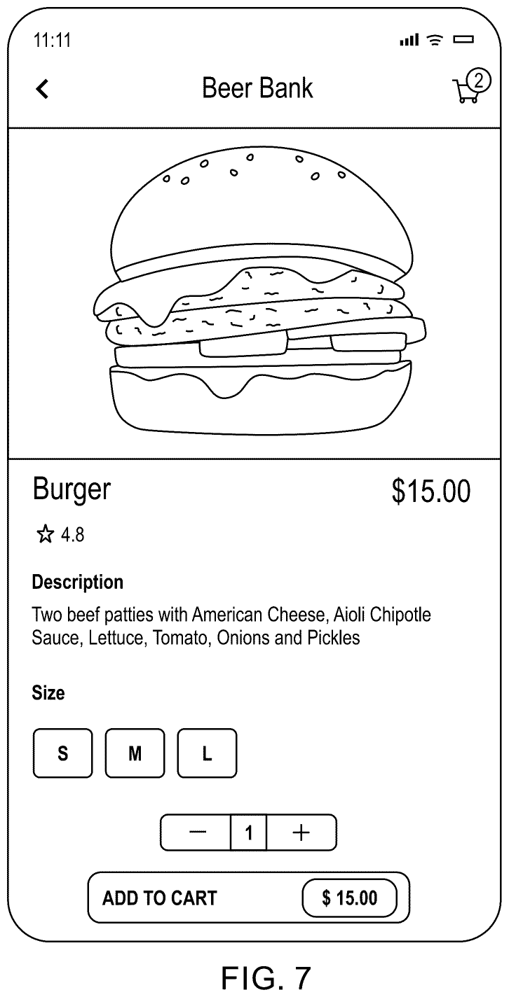

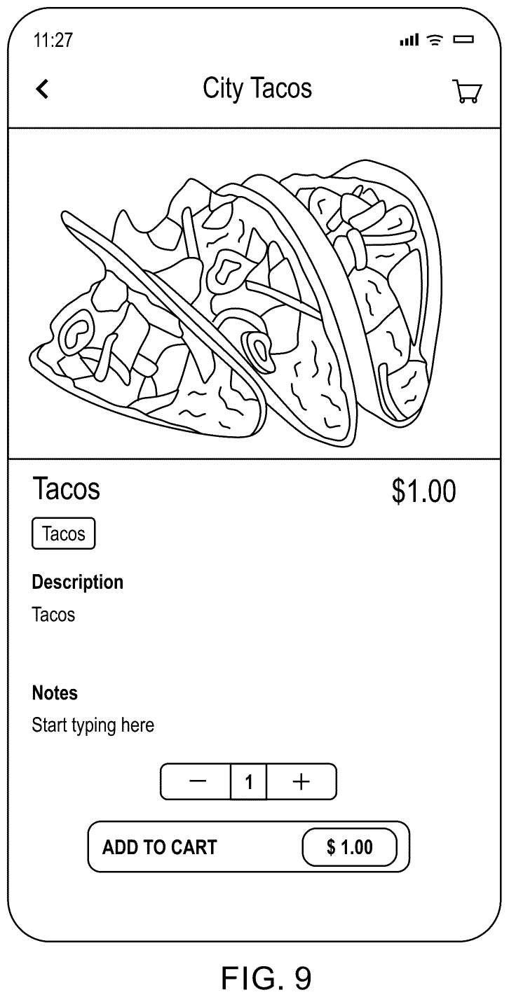

The specification interface 206 may be, for example, selection buttons, text entry field, drop-down menu, and so forth. The specification entered or selected by the user at the specification interface 206 may be, for example, an instruction, choice, size, or alteration, and so on. The specification entered or selected by the user may include a substitution, addition, removal, or amount, such as with respect to an ingredient of the food item. The specification entered or selected by the user may include a cooking amount (e.g., rare, medium, well, etc.) of meat, a spice level of the food item, or other preparation instruction. Additional specifications are applicable. For specific examples of an item page, see FIG. 7 and FIG. 9.

The item page 200 may include a link 210 (e.g., cart icon) to take the user to a cart page or cart. In implementations, the app in response to the user selecting or clicking on the link 210, displays a cart page or cart of the app at the user device.

FIG. 3 is an example of a cart page 300, which may be labeled as the cart or a depiction of the cart. The cart page 300 may be displayed, for example, in the app to the user in response to the user clicking on the link 210 (FIG. 2) and/or the add-to-cart button 208 (FIG. 2) on the item page of FIG. 2.

The food item entry 302 and the food item entry 304 are in the cart. In this example, the food item entry 302 corresponds to the food item of the item page 200 of FIG. 2. This embodiment of the cart page 300 includes the amount or number 306 (e.g., 1, 2, 3, etc.) of the food item entry 302 in the cart and the number 308 of the food item entry 304 in the cart. In implementations, the number 306 and the number 308 may be adjustable by the user. The cart restaurant) in which the order for the cart of food item entries 302, 304 will be placed and purchased by the user. The cart page 300 may include purchase information 312, such as the subtotal cost, tax, tip, total cost, payment method, user credit card information, and so on. If an order has not been placed, the cart page 300 may include a place-the-order link or button (not shown) for the user to select (click) to place an order for the cart food item entries 302, 304 congruent with the financial information 312.

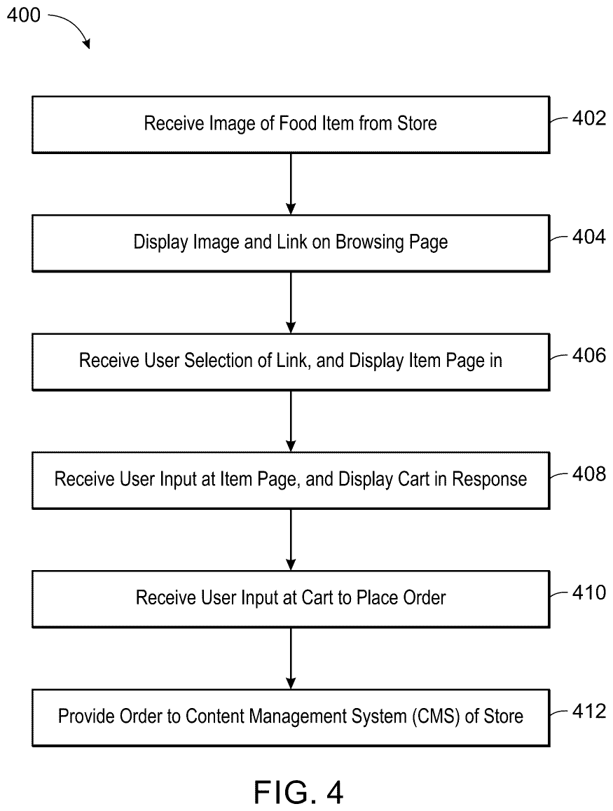

FIG. 4 is a method 400 of providing for a user to browse and order food. The method includes embodiments of the present app (platform). In implementations, the method can be characterized as a method of providing a service to a user for browsing and ordering food. The service is provided at least in part via embodiments of the present app.

At block 402, the method includes receiving information (e.g., an image of a food item, a description of the food item, and a price of the food item) from a store for the application (app). Multiple different images, descriptions, and prices for respective food items may be received from a store and multiple stores. Such may be received by or entered into the app. The store may be a provider (e.g., food provider, restaurant, etc.) of food items. In implementations, the store may upload (or otherwise provide) the information by interacting with the app or app manager. The method may include onboarding the store for the application. In implementations, the onboarding can include receiving from the store the image, the description, and the price.

At block 404, the method includes displaying to the user of the app at the user device the image (of a food item) and a link (e.g., an icon such as a cart icon) associated with the image on a browsing page or feed in the application. Multiple images of differing food items may be displayed on the browsing page (e.g., FIG. 1). Each image (e.g., photograph or video) of a food item on the browsing page may have a corresponding link (icon) on the browsing page for the user to select. The image as a video can be a reel (e.g., a video with no audio, less than 2 minutes in length, and/or a size limit such as less than 2 megabytes, etc.). The link (e.g., 104 of FIG. 1) may efficiently provide for the user of the app to go from browsing food items of various sources (stores) to information for considering and purchasing the food item within the same app in which the browsing is performed.

An image can feature more than one item, and in which the corresponding link (icon) can accommodate options for user selection between the multiple items in the image. Moreover, users (customers) can provide images that can be accessible by other users. The store can decide if the user-provided image is associated with the corresponding link (e.g., cart icon).

The app may be configured with the store-provided information as received (block 402) for consideration by the user in browsing and ordering food (food items). The method may include placing the image and the link (icon) on the browsing page. The method may include associating (configuring) the link (e.g., cart icon) with the food item.

At block 406, the method includes receiving selection of (e.g. click on) the link (e.g., an icon such as a cart icon) on the browsing page by a user and, in response, displaying an item page of the food item in the application. The item page may be displayed on a user device employing the app. For examples of an item page, see FIGS. 2, 7, and 9. In implementations, the image of the food item may be shown on the item page. If so, the method may include placing the image on the item page. In other words, the app may be configured with the image of the relevant food item (or similar image) depicted on the item page. As discussed, the item page may include the price and/or text description of the food item. As also discussed, the item page may also include an interface (e.g., buttons, text field, drop-down menu, etc.) to receive user entry or selection of a specification regarding the food item.

The item page may be configured to receive user input to add the food item of the item page to a cart in the application. For instance, the item page may include an add-to-cart button for the user to select (click) to add the food item to the cart in the app. The item page may include a cart icon that if clicked by the user, the application will display that cart page.

At block 408, the method includes receiving an input by the user at the item page to add the food item to a cart (e.g., by clicking an add-to-cart button on the item page) and, in response, the method displaying a cart page in the application indicating the food item added to the cart. In implementations, the cart page may be displayed in response to the user clicking on a cart icon on the item page or by other interaction of the user with the app. The cart page (e.g., a representation of the cart) may be displayed on a user device employing the application. The cart page can be called the cart or a depiction of the cart. For examples of a cart page, see FIGS. 3, 8, and 10.

At block 410, the method includes receiving an input by the user at the cart page to place an order including the food item. The cart page may include, for example, a place-the-button (not shown) for the user to click to place an order for the cart food item entries. In implementations, the user placing an order for the cart food item entries may be input (selected) by the user on an app page other than the cart page. The method may include indicating (providing indication) to the user that the order has been received and placed in response to the user clicking the place-to-order button or in response to other indication by the user to place the order.

At block 412, the method includes providing the order to a content management system (CMS) of the store that provides the food items of the entries in the cart. In particular, the order may be provided, for example, to a kitchen display system (KDS) of the content management system. In examples, the method may include arranging or facilitating delivery of the food item along with the user placing the order of the food item. For instance, the store or a third party may be utilized for delivery in response to the user selecting delivery as an option in the app. The method may include accommodating (attending to) payment from the user for the order. In implementations, a third party may be utilized to facilitate payment. In one example, the third party is Stripe, Inc. (a financial services company) having headquarters in Dublin, Ireland. Application program interfaces (API's) by Stripe, Inc. may be employed. Other third parties and their API's are applicable.

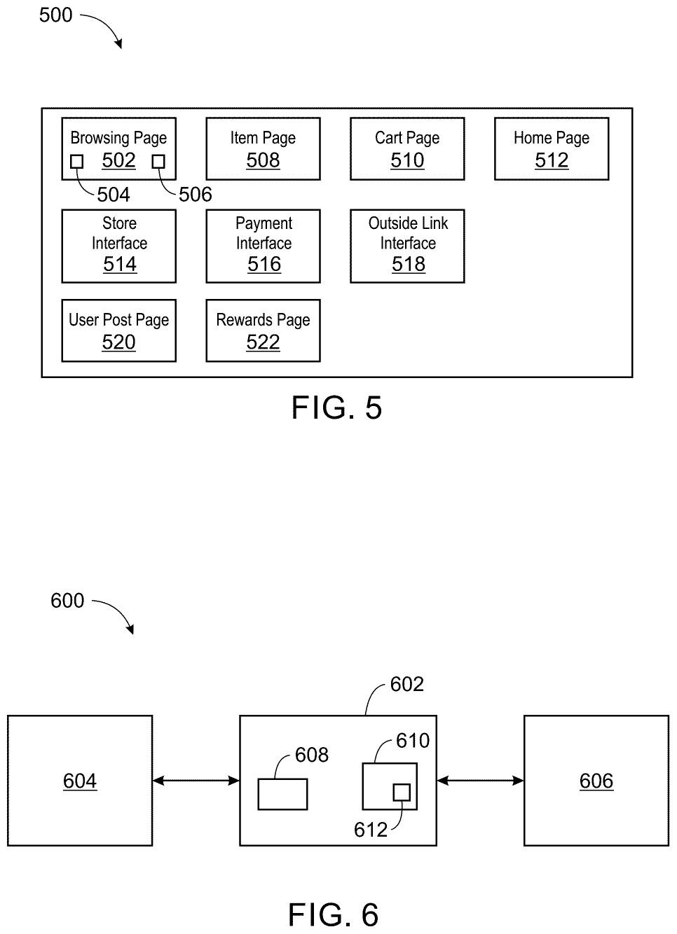

FIG. 5 is a representation of an application 500 (app) as a platform for a user browsing and ordering food, as generally discussed. The application 500 includes a browsing page 502. The browsing page 502 may be a browsing feed (or characterized with another label) and may be displayed in the app at the user device. The browsing page 502 includes [1] an image(s) 504 of a food item(s) and [2] a link(s) 506 [e.g., icon(s)] associated with the image(s). The image 504 may be, for example, a photograph or a video, or both. The application may be configured to place the image 504 (e.g., received from a store) and the link (e.g., cart icon) on the item page and associate the cart icon with the food item.

The link (e.g., an icon such as a cart icon) may beneficially take the user to an item page (or similar page) in the app for further consideration (and potential purchase) by the user of the food item depicted in the associated image. The app may comprehensively provide for both (a) user browsing of food items from multiple sources (stores) and (a) user purchasing the food item from a given source. In implementations, the images of the food items on the browsing page 502 may be a result of a user search for a food item performed within the app. Embodiments of the application 500 may include the browsing page 502 having the image of a food item and the cart icon associated with the image, wherein the application is configured to receive an input by a user (e.g., a click on the cart icon by the user) and, in response, display an item page.

The application 500 includes the item page 508, which may be displayed in the app at the user device in response to the user clicking on the link 506 (e.g., cart icon) on the browsing page 502. The item page 508 may include, for example, a price of the food item, an interface to receive a specification from the user, and an add-to-cart link (e.g., button) to receive an input by the user to add the food item to a cart in the application. Embodiments of the application 500 include the item page 508 showing the price of the food item, the interface to receive a specification from the user, and an add-to-cart button to receive an input by the user to add the food item to a cart in the application, and in response to that input, the application is configured to display a cart page (cart).

The application 500 includes the cart page 510, which may be displayed in the app at the user device in response to the user clicking on the add-to-cart link on the item page 508. The item page 502 may include, for example, a price of the food item, an interface to receive a specification from the user, and an add-to-cart button to receive an input by the user to add the food item to a cart in the application. Embodiments of the application 500 include the cart page configured to indicate the food item and the price, show a place-the-order button to receive an input by the user to place an order including the food item. In response to that input, the application is configured to provide the order to a CMS and/or KDS of a store associated with the image 504 of the food item selected via its corresponding link 506 by the user. In implementations, the application may be configured to indicate to the user that the order has been received from the user and placed at the store.

The application may include a home page 512 or an initial page. In implementations, the home page 512 or initial page can be in the form of a dashboard. The home page 512 may provide, for example, a user log-in to the app. In implementations, the home page may include a search field for the user to enter search terms (e.g., of a food item) to perform a search. In implementations, images of food items associated with results of the search may be placed on the browsing page 502. In implementations, the browsing page 502 may include the search field for user entry of text to perform the search.

The application 500 may include a store interface 514 to interact with store(s) that provide food items for purchase by the user. The application 500 may be configured via the store interface 514 to receive from the store the image 502 (placed by the app on the browsing page 504), the price of the food item (e.g., the price placed by the app on the item page 508 and the cart page 510), and a description of the food item (e.g., the description placed by the app on the item page 508). The application 500 may be configured via the store interface 514 to provide the order (e.g. placed by the user at the cart page 510) to the store CMS (and/or KDS). Other communications between the store and the app via the store interface 514 are applicable.

The application 500 may include a payment interface 516 to accommodate payment by the user for an order placed by the user at the cart page 510. The application 500 may be configured to facilitate payment by the user for the order. The payment interface 516 may interact with the user and with a third party, as discussed, to process payment by the user. Moreover, the payment interface or other feature of the application 500 may arrange for delivery of the food item(s) in the order if desired by the user.

The application 500 may include an outside link interface 518 configured to respond to the activating (selecting, clicking, etc.) of a link outside of (external to) the app, such as at a social media app or in a list of search engine results. The link may be a hyperlink that directs to the app. The app via the interface 518 may open the app at a user device in response to the user clicking on the link, for example, in a social media post or in search engine results. The application 500 can be configured at least via the interface 518 to interact with social media applications (e.g., Instagram, Facebook, etc.) or search applications (engines), or both. For example, a description and/or image of a food item along with the link to open the app may be posted on a social media application by an entity (e.g., food provider, user, third party, etc.). Moreover, food providers or other entities can provide a link (to open the application 500) in their information that may appear in search results of search engines (e.g., Google, Bing, etc.). See, for example, FIG. 11.

The application 500 may include a user post page 520 and a rewards page 522. The application 500 may be configured via the user post page 520 to provide for the user (receive from the user) to post images and comments regarding food items and stores, and for the user to receive rewards (e.g., monetary rewards) via the rewards page 522 in response. The application 500 may store the information posted by the user and show the user-posted information (e.g., images/comments of food items and stores) on the user post page 520. The rewards page 522 may show the monetary rewards (or other rewards) awarded to the user for posting information on the user post page 520.

FIG. 6 is a system 600 that includes a computing system 602 for managing (including configuring) the present application (platform) and interacting (communicating) with stores 604 and users 606. The interaction may be with computing devices at the stores 604 and with computing devices of the users 606. The interaction (communication) between the computing system 602 and the stores 604 (and between the computing system 602 and the computing devices of the users 606) may be, for example, via the Internet, as indicated by the two double-headed arrows. Again, the present application (app) is for a user to browse and order food items.

The computing system 602 includes a hardware processor 608 and memory 610 storing code 612 (e.g., logic, instructions, etc.) executed by the processor 608 to manage the application and interact with stores 604 and users 606 of the application. The stored code 612 may include the pages (and code for configuring the pages), interfaces (and code for relying on the interfaces), and links (and code for configuring or associating the links), and so on, of the app as discussed herein.

The computing system 602 may be single computing device or a computer, a server, a desktop, a laptop, multiple computing devices or nodes, a distributed computing system, control system, and the like. The processor 608 may be one or more processors, and may have one or more cores. The hardware processor(s) 608 may include a microprocessor, a central processing unit (CPU), graphic processing unit (GPU), or other circuitry. The memory 610 may include volatile memory (e.g., cache, random access memory or RAM, etc.), nonvolatile memory (e.g., hard drive, solid-state drive, read-only memory [ROM], etc.), and firmware, and the like.

The code 612 as executed by the processor 608 may be configured to interact with the stores 604 (providers of food items for purchase by the users 606) to receive and store images and other information of food items from the stores 604 for the application in the memory 610. The code 612 as executed by the processor 608 may configure the computing system 602 to send orders placed by the users 606 in the app to a respective CMS (and/or KDS) of the stores 604. The code 612 as executed may provide for other interactions between the computing system 602 and the stores 604. Moreover, the code 612 as configured may facilitate user payment of an order of a food item(s) to the stores 604 and attend to arranging of delivery of the order of the food item(s) to the users 606, as discussed. The code 612 as executed by the processor 608 may be configured for the computing system 602 to interact (communicate) with the users 606 and their computing devices to provide for the users 606 to browse and/or purchase food items via the app and their computing devices, as discussed.

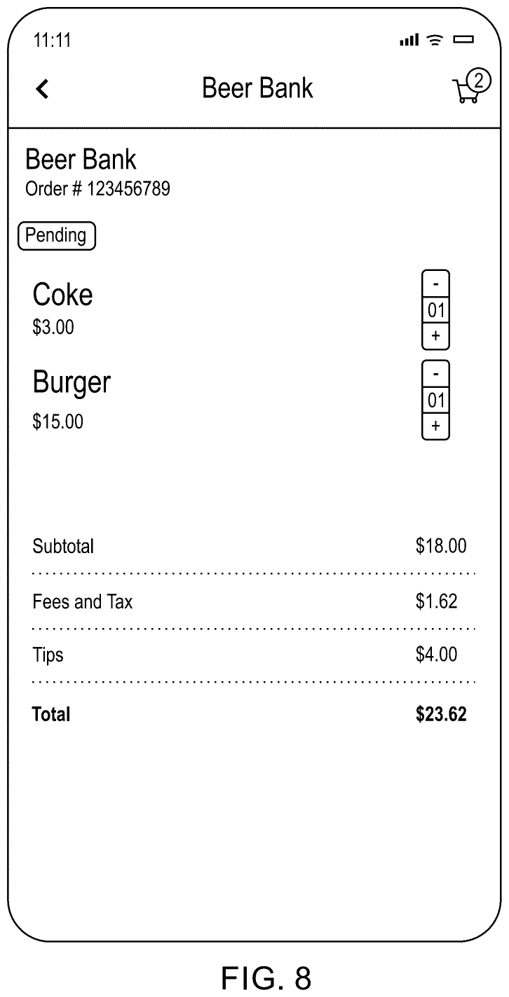

FIG. 7 is an example of an item page of the app that may be displayed on the user device (computing device). The item page as depicted can be generally a drawn representation of a screenshot on the user computing device. The item page illustrated in FIG. 7 may be analogous to the item page 200 of FIG. 2. In this example, the name “Beer Bank” of the store (restaurant) is depicted at an upper portion of the item page. An image of the food item as a hamburger is shown. The name “Burger” provided by the restaurant and the price for the food item (hamburger) are given below the image. A description is also given. The illustrated item page includes a specification interface (three buttons) for receiving user input of the size (small, medium, or large) of the hamburger. Below that, the item page includes an interface for the user to enter the number of hamburgers (Burger) to be ordered. The item page includes an “add to cart” button for the user to click to add the food item (hamburger) to a cart in the app. In implementations, the user clicking on the add to cart button below the specification interface (three buttons) and/or the user clicking on the cart icon at the upper right portion of the item page may take the user to the cart page illustrated in FIG. 8.

FIG. 8 is an example of a cart page (of the app) associated with the item page of FIG. 7 and that may be displayed on the user device (computing device). The cart page as depicted can be generally a drawn representation of a screenshot on the user computing device. The cart page illustrated in FIG. 8 may be analogous to the cart page 300 of FIG. 3. The cart page in FIG. 8 may be simply known as a depicted cart (or representation of the cart). The name “Beer Bank” of the store (restaurant) is given at an upper portion of the cart page. Two food item entries are depicted in the cart. The first is “Coke”. The second is “Burger” depicted on the item page of FIG. 7. The amount or number of each food item entry is noted as “01” and is adjustable by the user as indicated. The cart page has purchase information including the subtotal cost, fees and tax, tip, and total cost. The cart page may include a place-the-order link or button (not shown) for the user to select (click) to place an order for the cart food item entries congruent with the financial information. However, in this example, the order has been placed by the user and thus an order number is given in which the order is noted as pending.

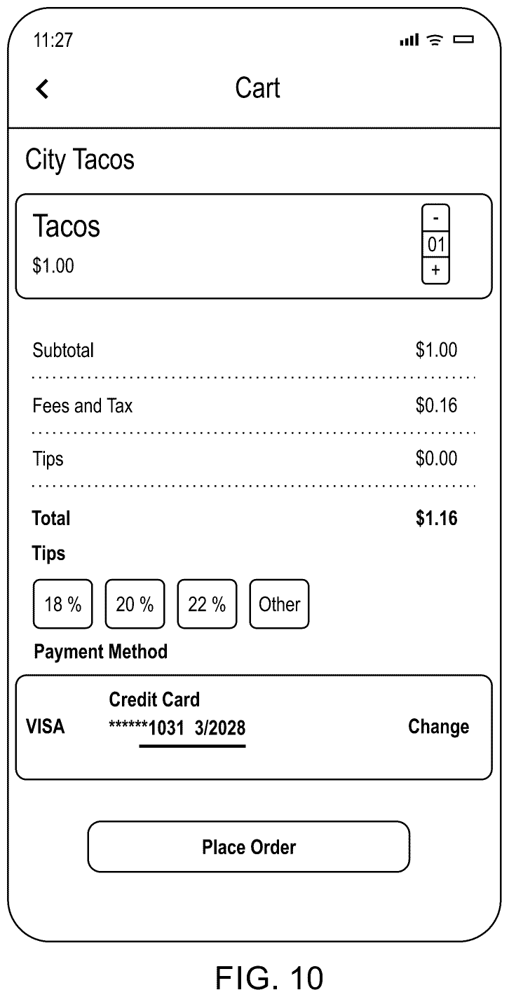

FIG. 9 is an example of an item page of the app that may be displayed on the user device (computing device) employing the app. The item page as depicted may be a drawn representation of a screenshot on the user computing device. The item page illustrated in FIG. 9 may be analogous to the item page 200 of FIG. 2. In this example, the name “City Tacos” of the store (restaurant) is depicted at an upper portion of the item page. An image of the food item as tacos is shown. The name “Tacos” provided by the restaurant and the price of the food item (per taco) is given below the image. The illustrated item page includes a specification interface “Notes” that is a field to receive user input of text of any instruction by the user regarding the tacos. Below that, the item page includes a specification interface for the user to input the desired number of tacos. Further, the item page includes an “add to cart” button for the user to click to add the food item (tacos) to a cart in the app. In implementations, the user clicking on the “add to cart” button and/or the user clicking on the cart icon at the upper right portion of the item page may take the user to the cart page illustrated in FIG. 10.

FIG. 10 is an example of a cart page (of the app) associated with the item page of FIG. 9 and that may be displayed on the user device (computing device). The cart page as depicted may be a drawn screenshot on the user computing device employing the app. The cart page illustrated in FIG. 10 may be analogous to the cart page 300 of FIG. 3. As mentioned, a cart page can be simply known as a depicted cart (or representation of the cart). The name “City Tacos” of the store (restaurant) is given at an upper portion of the cart page. A food item entry (the taco of the item page in FIG. 9) is depicted in the cart. The selected number of tacos is one, but the number is adjustable by the user as indicated. The cart page has purchase information including the subtotal cost, fees and tax, tips, total cost, tips selection, and credit card information. In this example, the illustrated cart page includes an interface (four buttons) for the user to select a tip amount (percent or other). The cart page includes credit card information of the user for payment of the order shown in the cart. The cart page provides a “change” link for the user to change the credit card information. This cart page include a “place order” button (link) for the user to select (click) to place an order for the cart food item entries congruent with the financial information.

FIG. 11 is an example of search results of the search term “street tacos” performed with the Google search engine. The search results are images of food items with some text below each image. A hypothetical result (entry) in these Google search results is for “Taco Stand” denoted with “Kezo” that is an example of a name for the present app. In response to a user selecting (clicking on) that particular search result, an embodiment of the present app may be opened on the user computer device employing the app. The user may then proceed with considering and purchasing the food item (street tacos from Taco Stand) via the app.

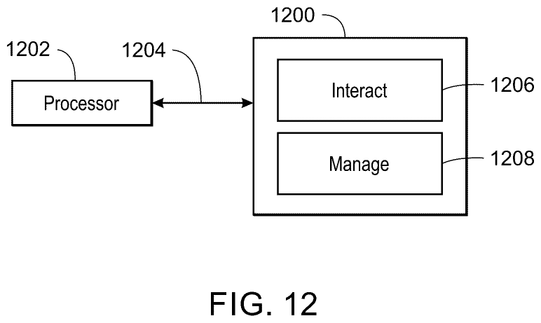

FIG. 12 is a block diagram depicting a tangible, non-transitory, computer (machine) readable medium 1200 having the present application and for managing (including configuring) the present application (platform) and interacting (communicating) with stores and users of the application. As discussed, the present application (app) is for a user to browse and order food items.

The computer-readable medium 1200 may be accessed by a hardware processor 1202 over a computer interconnect 1204. The processor 1202 may be a controller, a computing system processor, a server processor, a compute-node processor, a workstation processor, a remote computing device processor, a microprocessor, a CPU, or other processor. The tangible, non-transitory computer-readable medium 1200 may include executable instructions or code to direct the processor 1202 to perform the operations of the techniques described herein, such as to managing (including configuring) the present application (platform) and interacting (communicating) with stores and users of the application. The various executed code components discussed herein may be stored on the tangible, non-transitory computer-readable medium 1200, as indicated in FIG. 12.

For example, an interact code 1206 may include executable instructions to direct the processor 1202 to receive an image of a food item, a description of the food item, and a price of the food item from a store for the application. The interact code 1206 may include executable instructions to direct the processor 1202 to provide an order of food items placed by a user in the app to a CMS and/or KDS of the store (e.g., restaurant). The interact code 1206 may include executable instructions to direct the processor 1202 to receive various input by the user (as discussed) and provide input/output for other entities such as payment systems and delivery companies. A manage code 1208 may include executable instructions to direct the processor 1202 to configure the application, display app pages at the user device in response to user input, and so forth. It should be understood that any number of additional executable code components not shown in FIG. 1200 may be included within the tangible non-transitory computer-readable medium 1200 depending on embodiments of the application.

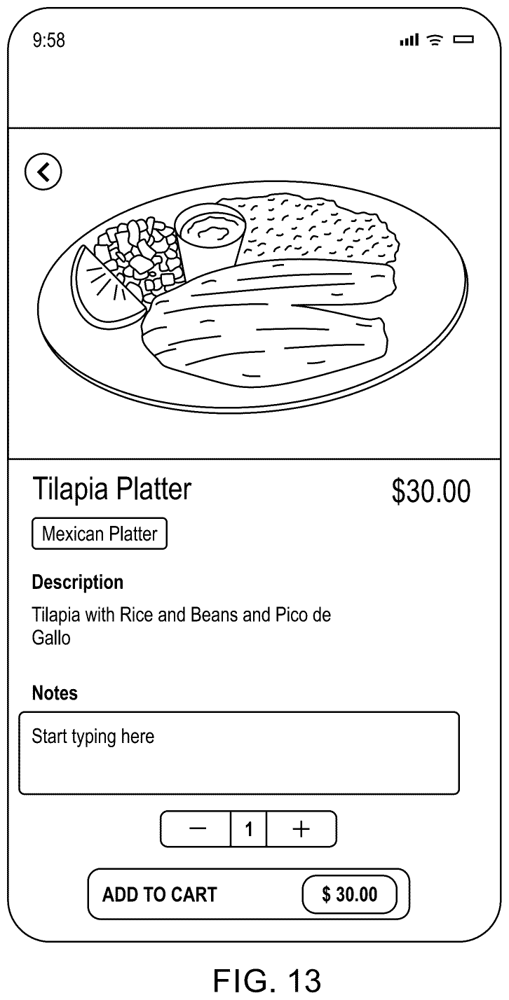

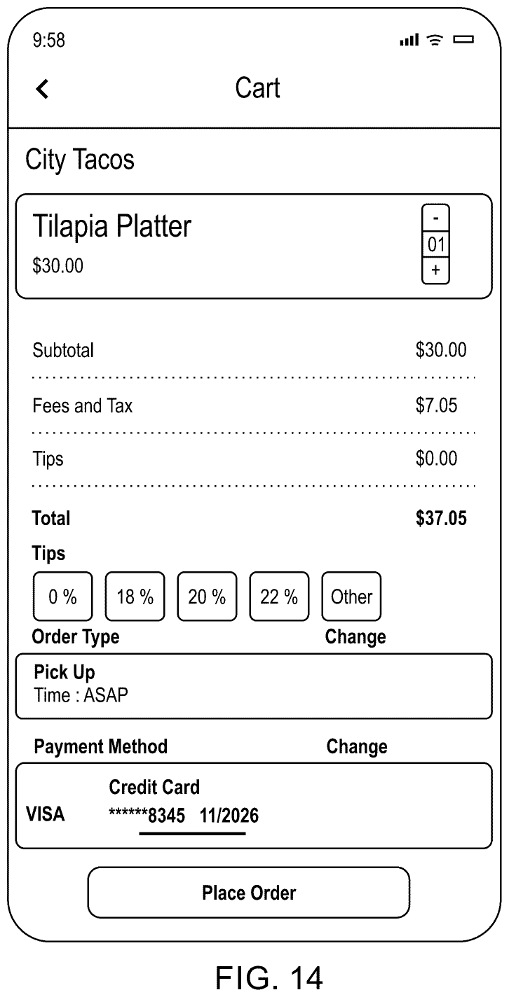

FIG. 13 is an example of an item page of the app that may be displayed on the user device (computing device). The item page as depicted is a drawn version of a screenshot that may be displayed on the user computing device. The item page illustrated in FIG. 13 may be analogous to the item page 200 of FIG. 2. An image of the food item as a tilapia platter is shown. The name “Tilapia Platter” provided by the restaurant and the price for the food item (tilapia platter) are given below the image. A description is also given. The illustrated item page includes a specification interface (text field) for receiving text entry from a user. Below that, the item page includes an interface for the user to enter the number of tilapia platters to be ordered. The item page includes an “add to cart” button for the user to click to add the food item (hamburger) to a cart in the app. In implementations, the user clicking on the add to cart button below the specification interface (text field) may take the user to the cart page illustrated in FIG. 14.

FIG. 14 is an example of a cart page (of the app) associated with the item page of FIG. 13 and that may be displayed on the user device (computing device). The cart page as depicted generally as a drawn version of a screenshot displayed on the user computing device. The cart page illustrated in FIG. 14 may be analogous to the cart page 300 of FIG. 3. The cart page in FIG. 14 may be simply known as a depicted cart (or representation of the cart). The name “City Tacos” of the store (restaurant) is given at an upper portion of the cart page. The food item entry “Tilapia Platter” (along with the price of $30.00) is depicted in the cart and is associated with the that on the item page of FIG. 13. The cart page has purchase information including the subtotal cost, fees and tax, tip, and total cost. This cart page includes a place order button (link) for the user to select (click) to place an order for the cart food item entry congruent with the financial information. The order type may be changed by the user. The order type may be, for example, pick up, delivery, dine-in, etc. As depicted, the user has selected pick up for the order type. [Will paraphrase the claims here when claims are finalized.]

In view of the foregoing, the present disclosure may provide for an application for browsing and ordering food items. The methods, systems, and application may include any of the various features disclosed herein, including one or more of the following statements.

Statement 1. [To be completed when the claims are finalized.]

The present embodiments are well adapted to attain the ends and advantages mentioned as well as those that are inherent therein. The particular embodiments disclosed are illustrative only, as the present embodiments may be modified and practiced in different but equivalent manners apparent to those skilled in the art having the benefit of the teachings herein. Although individual embodiments are discussed, all combinations of each embodiment are contemplated and covered by the disclosure. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure.

What is claimed is:

1. A method of providing for a user to browse and order food, comprising:
receiving an image of a food item, a description of the food item, and a price of the food item from a store for an application;
displaying the image and an icon associated with the image on a browsing page in the application;
receiving a click on the icon by the user and, in response, displaying an item page of the food item in the application;
receiving an input by the user at the item page to add the food item to a cart and, in response, displaying a cart page in the application indicating the food item added to the cart;
receiving another input by the user at the cart page to place an order comprising the food item;
indicating to the user that the order has been placed; and
providing the order to the store.

2. The method of claim 1, wherein providing the order to the store comprises providing the order to a content management system of the store.

3. The method of claim 2, wherein providing the order to the content management system comprises providing the order to a kitchen display system (KDS) of the content management system.

4. The method of claim 1, comprising receiving a specification entered by the user at the item page, wherein the item page comprises the description, and wherein the image comprises a photograph or a video, or both.

5. The method of claim 4, wherein the video comprises a reel that is the video less than 2 minutes in length.

6. The method of claim 1, comprising accommodating payment from the user for the order.

7. The method of claim 1, comprising onboarding the store for the application.

8. The method of claim 7, wherein the onboarding comprises the receiving from the store the image, the description, and the price.

9. The method of claim 1, comprising:
placing the image and the icon on the browsing page; and
associating the icon with the food item.

10. The method of claim 1, wherein the browsing page comprises multiple images of food items, respectively, wherein the multiple images comprise the image, and wherein the food items comprise the food item.

11. An application for browsing and ordering food, comprising:
a browsing page comprising an image of a food item and a cart icon associated with the image, and wherein the application is configured to receive a first input by a user comprising a click on the cart icon by the user and, in response, display an item page;
the item page comprising a price of the food item, an interface to receive a specification from the user, and an add-to-cart button to receive a second input by the user to add the food item to a cart in the application, wherein the application is configured to display a cart page in response to the second input; and
the cart page indicating the food item and the price, the cart page comprising a place-the-order button to receive a third input by the user to place an order comprising the food item, wherein the application is configured to provide the order to a content management system of a store in response to the third input.

12. The application of claim 11, wherein the application is configured to indicate to the user that the order has been received, and wherein the image comprises a photograph or a video, or both.

13. The application of claim 11, wherein the application is configured to receive from the store the image, the price, and a description of the food item from the store, and wherein the item page comprises the description.

14. The application of claim 13, wherein the application is configured to place the image and the cart icon on the browsing page and associate the cart icon with the food item.

15. The application of claim 11, wherein the content management system comprises a kitchen display system (KDS), and wherein the application is configured to facilitate payment by the user for the order.

16. The application of claim 11, wherein the browsing page comprises multiple images of food items, respectively, wherein the multiple images comprise the image, and wherein the food items comprise the food item.

17. A non-transitory, computer-readable medium comprising instructions executable by a processor of a computing device to:
receive an image of a food item, a description of the food item, and a price of the food item from a store for an application;
display the image and an icon associated with the image on a browsing page in the application;
receive a click on the icon by a user and, in response, display an item page of the food item in the application;
receive a specification entered by the user at the item page;
receive an input by the user at the item page to add the food item to a cart and, in response, display a cart page in the application indicating the food item added to the cart;
receive another input by the user at the cart page to place an order comprising the food item;
provide the order to a content management system of the store.

18. The non-transitory, computer-readable medium of claim 17, wherein the item page comprises the description, wherein the image comprises a photograph or a video, or both, and wherein the content management system comprises a kitchen display system (KDS).

19. The non-transitory, computer-readable medium of claim 17, wherein the browsing page comprises multiple images of food items from different stores, respectively.

20. The non-transitory, computer-readable medium of claim 17, comprising instructions executable by the processor to accommodate payment from the user for the order.
